(19) United States
(12) Patent Application Publication
(10) Pub. No.: US 2021/0100222 A1
(43) Pub. Date: Apr. 8, 2021

(54) SHELF READY SHIPPER WITH GRAVITY FEED OPENING

(71) Applicant: WestRock Shared Services, LLC, Atlanta, GA (US)

(72) Inventors: Timothy B. Hawkins, Middletown, OH (US); Thomas F. Lang, Middletown, OH (US)

(21) Appl. No.: 16/595,562

(22) Filed: Oct. 8, 2019

(51) Int. Cl. A01K 39/012; B65D 5/54; B65D 5/42

(52) U.S. Cl. CPC A01K 39/012; B65D 5/4266; B65D 5/542

(57) ABSTRACT

A blank for a container includes a plurality of panels connected together at fold lines configured for extending at least partially around an interior space, including a front panel, a first side panel, a rear panel and a second side panel. The blank includes a plurality of top flaps and a plurality of bottom flaps foldably connected to opposed edges of each of the first side panel, the second side panel, the front panel, and the rear panel. The plurality of bottom flaps includes a tray flap foldably connected to an edge of the front panel opposite the top flap, the tray flap being configured to fold toward and be adhered to a bird feeder tray defined by a line of weakness in the front panel.

### BACKGROUND OF THE INVENTION

### 1. Field of the Invention

The present disclosure relates to shelf-ready containers, and more particularly to containers with gravity fed bird-feeder dispensers.

### 2. Description of Related Art

Retail ready or shelf ready containers can be used both for storing product during shipping and for dispensing product in the retail setting. Gravity fed dispensing configurations provide an opening near the bottom of a container so that consumers can obtain the product directly from the container. As more and more product is removed from the container by consumers, gravity continues to move the remaining product in the container down toward the opening.

The conventional techniques have been considered satisfactory for their intended purpose. However, there is an ever present need for improved shelf ready containers. This disclosure provides a solution for this need.

### SUMMARY OF THE INVENTION

A container includes a plurality of panels connected together at fold lines configured to extending at least partially around an interior space, including a front panel, a first side panel, a rear panel and a second side panel. A plurality of top flaps and a plurality of bottom flaps are foldably connected to opposed edges of each of the first side panel, the second side panel, the front panel, and the rear panel. The plurality of bottom flaps includes a tray flap foldably connected to an edge of the front panel opposite the top flap. The tray flap is configured to fold toward and be adhered to a bird feeder tray defined by a line of weakness in the front panel.

The bird feeder tray can be nicked into place along a top edge and two side edges of the bird feeder tray by lines of perforation. The bird feeder tray can be foldably connected to the front panel along the bottom edge of the bird feeder tray. The bird feeder tray can be positioned within the front panel such that a space is maintained between the bottom edge of the bird feeder tray and the foldable connection between the front panel. The space between the bottom edge of the bird feeder tray and foldable connection can define a sill that retains product placed within the interior space.

The bird feeder tray can be configured to be manually converted from a shipping configuration to a retail configuration by breaking lines of perforation and pulling the bird feeder tray away from the front panel to create an opening in the front panel to access the interior space. The tray flap can include a pair of wings foldably connected to opposed edges of the tray flap. The opposed wings can be shaped as half-hemispheres and a rounded edge of each wing can be radiused to clear an edge of the opening when the bird feeder tray is pulled away from the front panel. Each wing can include a locking slot, and each locking slot can be configured to engage an edge of the opening in the front panel to prevent the bird feeder tray from opening more than 90 degrees with respect to the front panel.

The tray flap can include one or more adhesive locations to adhere the tray flap to the front panel when the tray flap is folded. The tray flap can include one or more slits parallel to the fold line between the tray flap and the front panel. The slits can be configured to promote folding of the tray flap towards the front panel.

An adhesive flap can be foldably connected to either the rear panel or the first side panel. The tray flap can be folded and adhered to the front panel, and first side panel and the rear panel can be folded such that the adhesive flap adheres the panels together into a joined knocked down box.

A blank for a container includes a plurality of panels connected together at fold lines configured for extending at least partially around an interior space, including a front panel, a first side panel, a rear panel and a second side panel. A plurality of top flaps and a plurality of bottom flaps are foldably connected to opposed edges of each of the first side panel, the second side panel, the front panel, and rear panel. The plurality of bottom flaps includes a tray flap foldably connected to an edge of the front panel opposite the top flap, the tray flap being configured to fold toward and be glued to a bird feeder tray defined by a line of weakness in the front panel.

The bird feeder tray can be defined along a top edge and two side edges of the bird feeder tray by lines of perforation. The bird feeder tray can be foldably connected to the front panel along a bottom edge of the bird feeder tray. The bird feeder tray can be positioned within the front panel, such that a space is maintained between the bottom edge of the bird feeder tray and the foldable connection between the front panel and the tray flap. The bird feeder tray can be configured to be manually converted from a shipping configuration to a retail configuration by breaking lines of perforation and pulling the bird feeder tray away from the front panel to create an opening in the front panel to access the interior space.

The tray flap can include a pair of wings foldably connected to opposed edges of the tray flap. A curved edge of each wing can be radiused to clear an edge of the opening when the bird feeder tray is pulled away from the front panel. Each wing can include a locking slot, and each locking slot can be configured to engage an edge of the opening in the front panel to prevent the bird feeder tray from opening more than 90 degrees with respect to the front panel. The tray flap can include one or more adhesive locations to adhere the tray flap to the front panel when the tray flap is folded. The tray flap can include one or more slits parallel to the fold line between the tray flap and the front panel. The slits can be configured to facilitate folding of the tray flap towards the front panel.

An adhesive flap can be foldably connected to either the rear panel or the first side panel. The tray flap can be folded and adhered to the front panel and first side panel and the rear panel are folded such that adhesive flap adheres the panels together into a joined knocked down box. The joined knocked down box can be palletized for shipment in bulk.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 is a plan view of an exemplary embodiment of a blank constructed in accordance with the present disclosure, showing the panels, bird feeder tray, end flaps, adhesive flap, tray flap, and fold lines;

FIG. 2 is a plan view of a second embodiment of a blank constructed in accordance with the present disclosure;

FIG. 3 is a perspective view of the blank of FIG. 1, showing the tray flap being folded to meet the bird feeder tray;

FIG. 4 is a perspective view of the blank of FIG. 1, showing the panels being folded to overlap the adhesive flap and the panel on the opposite end of the blank;

FIG. 5 is a perspective view of the blank of FIG. 1 adhered into a knocked down flat box;

FIG. 6 is a perspective view of the knocked down container of FIG. 5 racked open for set up;

FIG. 7 is a perspective view of the racked open container of FIG. 5 with end flaps being folded to create a closed bottom end of the container;

FIG. 8 is a perspective view of the container of FIG. 5 with end flaps folded to create a top closed end of the container, in the shipping configuration of the container;

FIG. 9 is a perspective view of the container of FIG. 5 with the bird feeder tray deployed in the open position for dispensing product from the container, in the retail configuration of the container;

FIG. 10 is a perspective view of the container of FIG. 5 with the container in the retail configuration and loaded with product that can be withdrawn from the deployed bird feeder tray; and

FIG. 11 is a perspective view of a plurality of the containers of FIG. 5 in retail configuration arranged together and presented in a retail display.

### DETAILED DESCRIPTION OF THE PREFERRED EMBODIMENTS

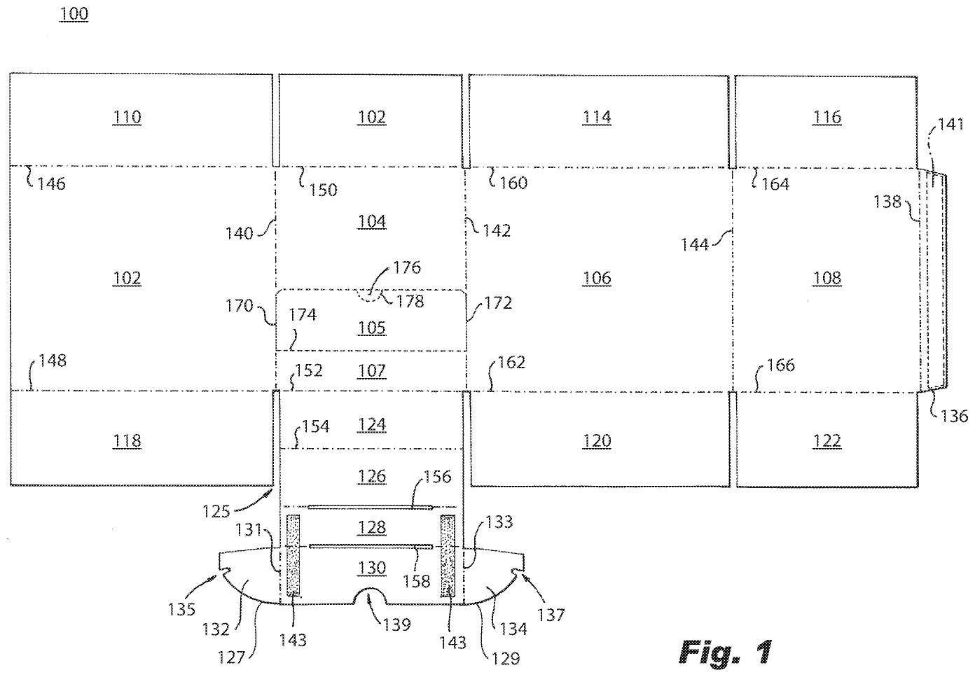

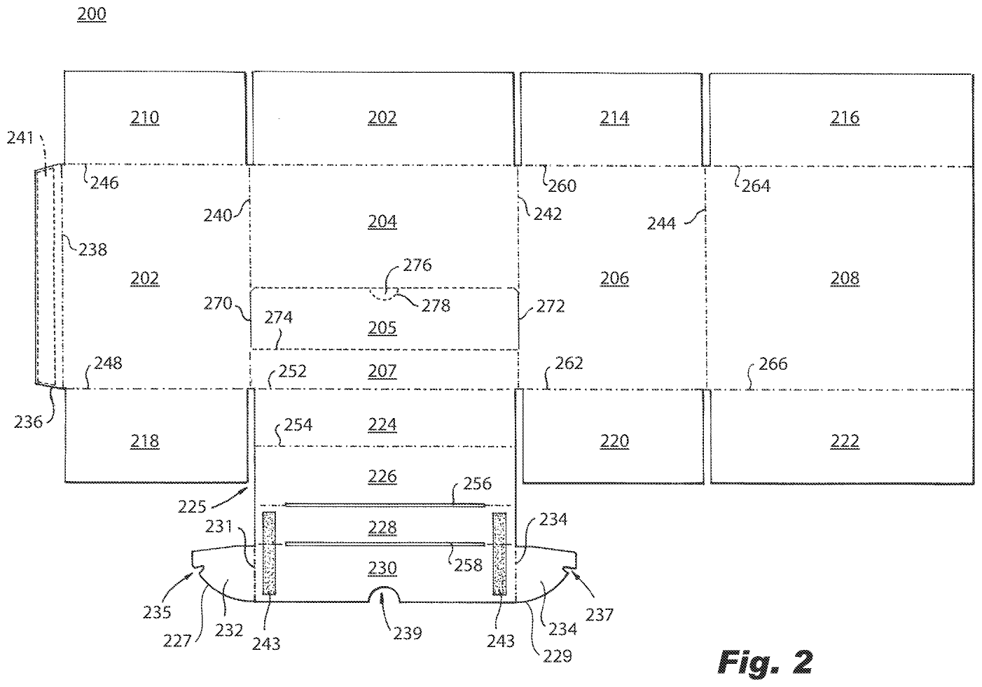

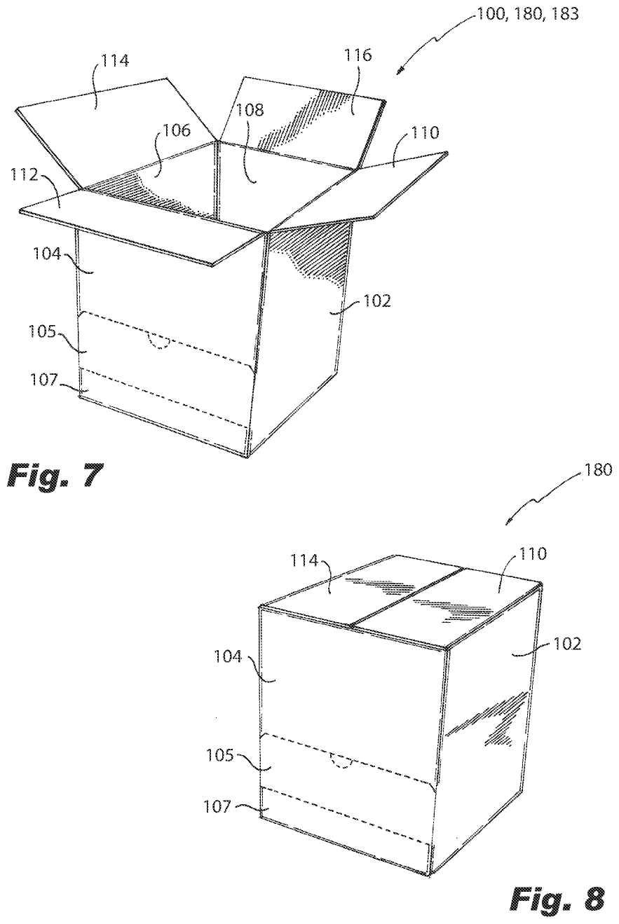

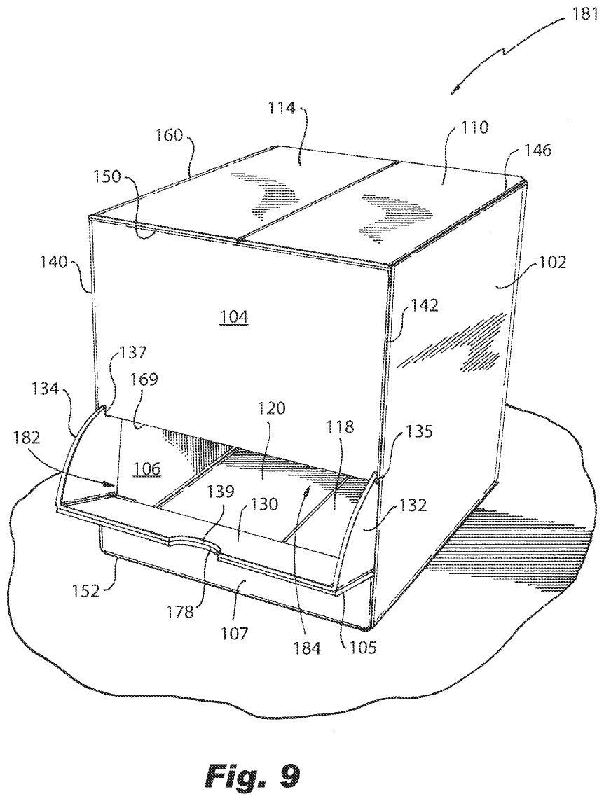

Reference will now be made to the drawings wherein like reference numerals identify similar structural features or aspects of the subject disclosure. For purposes of explanation and illustration, and not limitation, a view of an exemplary embodiment of a blank for a container in accordance with the disclosure is shown in FIG. 1 and is designated generally by reference character 100. Other embodiments of blanks and containers in accordance with the disclosure, or aspects thereof, are provided in FIGS. 2-10, as will be described. The systems and methods described herein can be used for shipping product and for gravity fed dispensing of product in a retail setting. The blank 100 of FIG. 1 can be formed into the container 180, 181 shown in FIGS. 8-9.

Referring now to FIG. 1, the blank 100 includes a plurality of panels including a first side panel 102, front panel 104, second side panel 106, and rear panel 108 connected together at respective fold lines 140, 142, 144 to extend at least partially around an interior space 184 (identified in FIG. 9). The first side panel 102 connects to the front panel 104 along fold line 140. The front panel 104 connects to the second side panel 106 along fold line 142. The second side panel 106 connects to the bottom panel 108 along fold line 144.

Four top flaps 110, 112, 114, 116 are each foldably connected to a respective one of the panels 102, 104, 106, 108 along fold lines 146, 150, 160, 164. Four bottom flaps 118, 125, 120, 122 are each foldably connected to a respective one of the panels 102, 104, 106, 108 along fold lines 148, 152, 162, 166. One of the bottom flaps 125 is a tray flap 125. An adhesive flap 136 is foldably connected to the second side panel 108 along fold line 138. Adhesive 141 may be applied to the adhesive flap 136.

Within the front panel 104 is a bird feeder tray 105. The bird feeder tray 105 is nicked into position within the front panel 104 with perforations along a top bird feeder tray edge 168 and two side bird feeder tray edges 170, 172. The bird feeder tray 105 is foldably connected to the front panel 104 along fold line 174. The perforated top 168 and side edges 170,172 are configured to be manually broken such that the bird feeder tray 105 can be converted from a shipping configuration 180 (as displayed in FIG. 8) to a retail configuration 181 (as displayed in FIG. 9) by pulling the bird feeder tray 105 away from the front panel 104. As the bird feeder tray 105 is manually pulled away from the front panel 104, it hinges along fold line 174 to create an opening 182 in the front panel 104 (as depicted in FIG. 9). The opening 182 allows consumer access to product 185 within the interior space 184 of the assembled container 180, 181 (as depicted in FIG. 9).

The side bird feeder tray edges 170, 172 can be positioned along fold lines 140, 142 such that the bird feeder tray 105 spans the entire width of the front panel 104. It is also contemplated that the side bird feeder tray edges 170, 172 need not be positioned along the fold lines 140, 142, such that the bird feeder tray 105 is narrower in width than the front panel 104. The bird feeder tray 105 is positioned within the front panel 104 so as to provide for a space 107 between fold lines 174, 152. The space 107 defines a sill 107 which functions to retain product 185 within the interior 184 of the assembled container in retail configuration 181 when the bird feeder tray 105 is hinged open in the retail configuration 181. To aid in the manual conversion from shipping configuration 180 to retail configuration 181, a lunate shaped punch-out area 176 is defined within the bird feeder tray 105 along a line of perforation 178. A finger can be inserted into the lunate punch-out 176 to provide additional hold while pulling the bird feeder tray 105 to hinge the tray 105 open as needed to complete the conversion to retail configuration 181.

Also depicted in FIG. 1 is the tray flap 125 which is foldably connected to the front panel 104 along a fold line 152. The tray flap 125 has upper 124, middle 126, 128, and lower subparts 130 that are defined by fold lines 154, 156, 158. Fold lines 156, 158 can include slots or cuts to aid in folding the tray flap 125. Adhesive 143 may be applied to the tray flap 125, particularly in the middle 128 and lower 130 subparts of the tray flap 125.

A pair of opposed wing flaps 132, 134 are foldably connected to opposed edges of the lower portion 130 of the tray flap 125 along respective fold lines 131, 133. The opposed wing flaps 132, 134, are half-hemispherically shaped. The half-hemisphere shape of the wing flaps 132, 134 includes a respective rounded edge 127, 129 that is radiused to clear an opening edge 169 (as depicted in FIG. 9) of the opening 182 when the bird feeder tray 105 is pulled away from the front panel 104. The wing flaps 132, 134 include locking slots 135, 137 which are configured to engage the edge 169 formed when the top edge 168 of the bird feeder tray 105 is broken and the bird feeder tray 105 is pulled away from the front panel 104. The locking slots 135, 137 engage the opening edge 169 of the opening 182 to prevent the bird feeder tray 104 from hinging open more than 90 degrees with respect to the front panel 104. The lower portion 130 of the tray flap 125 includes a lunate shaped cut out 139, which pairs with the lunate shaped punch-out area 176 during assembly of the container 180, 181.

With respect now to FIG. 2, an embodiment of a blank 200, similar to the blank 100 is depicted. The blank 200 is similar in most regards to the blank 100, except that the adhesive flap 236 is foldably connected to the first side panel 202. The proportions of the panels 202, 204, 206, 208 of the blank 200 are shown to vary from the blank 100. For example, the front panel 204 and rear panel 208 are wider than the first 202 and second side panels 206, in comparison to the blank 100, where the front panel 104 and rear panel 108 are narrower than the first 102 and second 104 side panels.

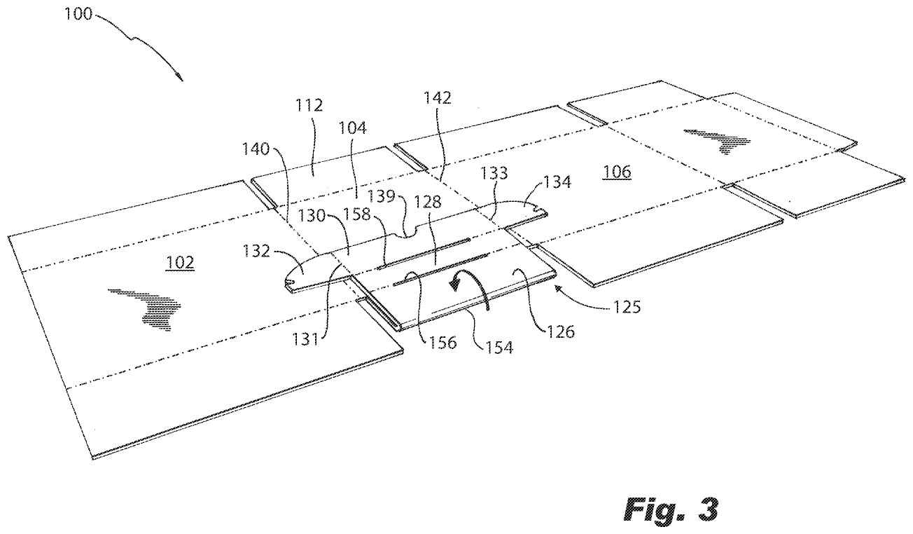

With reference now to FIG. 3, the beginning of the process of assembling the container 180, 181 from the blank 100 is shown. Tray flap 125 is depicted having been folded across fold line 154 to overlap with the bird feeder tray 105 (some elements not visible in FIG. 3 are obscured due to folding, and are depicted in FIG. 1). A middle subpart 126 of the tray flap 125 overlaps with the upper subpart 124 after folding across fold line 154 (upper subpart 124 obscured in FIG. 3, is depicted in FIG. 1). Likewise, another middle subpart 128 overlaps with the sill 107 (obscured in FIG. 3, is depicted in FIG. 1), and lower subpart 130 overlaps with the bird feeder tray 105 (obscured in FIG. 3, is depicted in FIG. 1). When the tray flap 125 folds across fold line 154, each of the wings 132, 134 overlaps with portions of the first 102 and second 104 side panels, and the fold lines 131 and 133 between the wings and the tray flap 125 overlap with fold lines 140, 142 between the panels 102, 104, 106. After folding, the tray flap 125 may be adhered into position with adhesive 141.

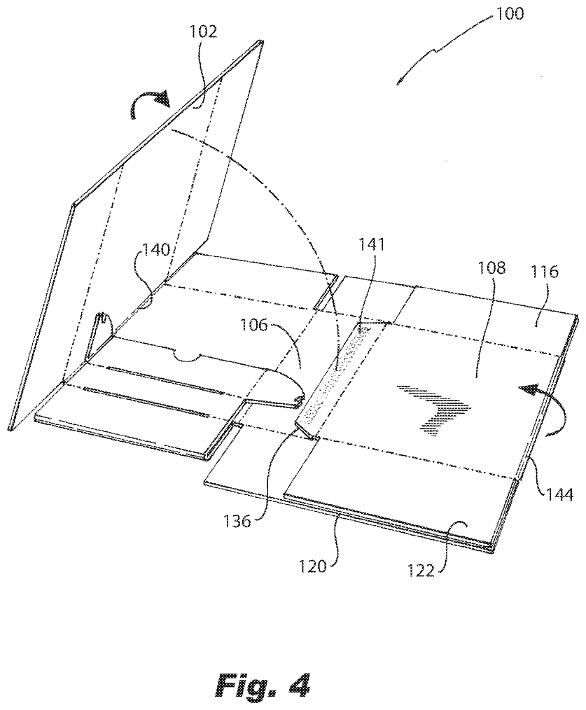

With reference now to FIG. 4, the assembly of the container 180, 181 from the blank 100 continues. The first side panel 102 and the rear panel 108 are folded across fold lines 140, 144, respectively.

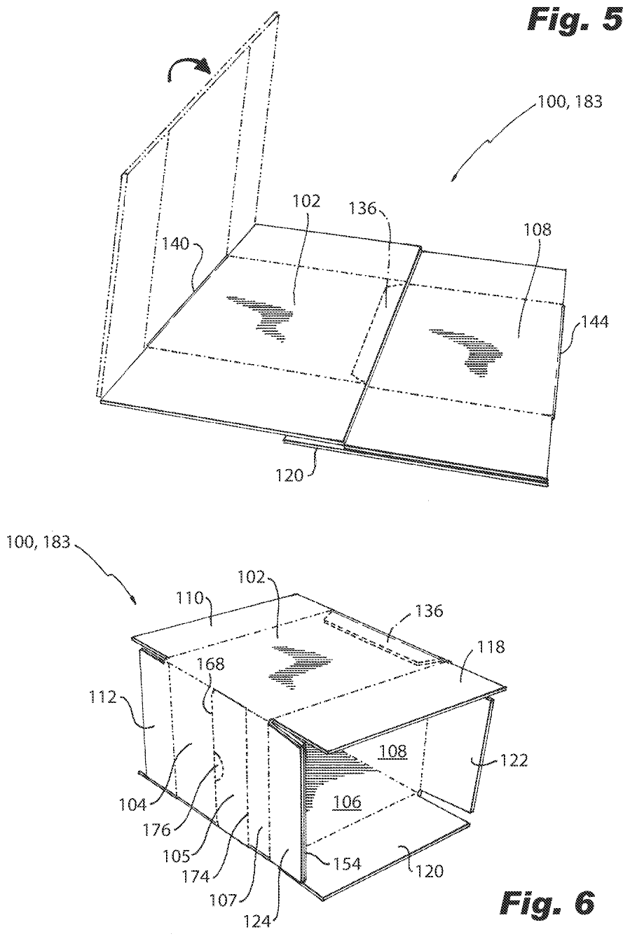

With reference now to FIG. 5, the container 180, 181 formed from the blank 100 is shown in a knocked down container format 183. In the knocked down container format 183, the adhesive flap 136 (as depicted in FIG. 4) is adhered to the first side panel 102. In this form shown in FIG. 5, multiple knocked down containers 183 can be palletized and shipped in bulk, e.g. from a first plant where the knocked down containers 183 are made to a second plant where the blanks are erected and filled with product.

With reference now to FIG. 6, the knocked down container 183 is shown being racked open. The process of racking open the container can be performed without the need for specialized packaging equipment, the bird feeder tray 105 does not interfere. Traditionally, containers with a gravity feed designed opening require special handling or assembly steps to erect the container. In contrast, the container r 180, 181, 183 can be treated as a standard shipping container without specialized steps for assembly or attention needed during transport.

With reference now to FIG. 7, the container 180 is shown with the bottom flaps 118, 120, 122 folded along fold lines 148, 162, 166, and the tray flap 125 folded across fold line 156 to enclose the bottom of the container 180. The bottom flaps may be held in place or sealed with packaging tape.

With reference now to FIG. 8, the container 180 is shown with the top flaps 110, 112, 114, 116 folded across fold lines 146, 150, 160, 164 to enclose the top end of the container 180. The top flaps may be held in place or sealed with packaging tape. The container 180 is shown in FIG. 8 in shipping configuration, e.g., with the bird feeder tray 105 nicked into place in the front panel 104. The bird feeder tray is nicked into place with sufficient resilient force to ensure the structural integrity of the container 180 in shipping configuration. Any product 185 placed in the interior 184 is protected during the standard rigors of shipment and transport without damage occurring that is in excess of what would be expected from a standard container without a bird feeder tray 105 and its associated perforated edges 168, 170, 172. For example, the bird feeder tray 105 and the perforated edges 168, 170, 172 should remain unbroken until conversion to retail configuration 181 is intended.

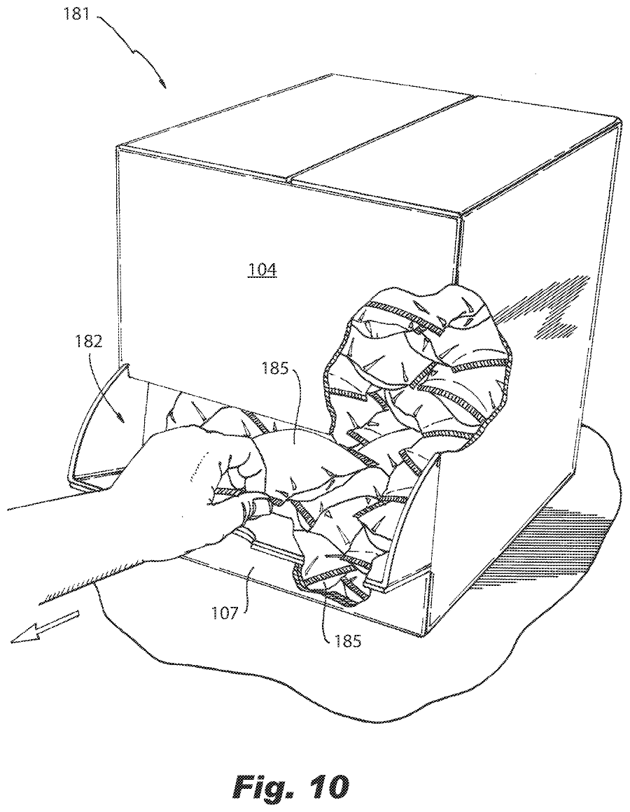

With reference now to FIG. 9, the container 181 is shown in retail configuration. The bird feeder tray 105 is shown hinged open along the fold line 174 with the perforated edges 168, 170, 172 broken to create an opening 182 in the front panel 104. The opening 182 exposes the interior 184 of the container, where product 185 may be placed (product shown in FIG. 10). Visible in FIG. 9 is a locking slot 137 engaged with the edge 169 of the opening 182 to hold the bird feeder tray 105 from opening beyond 90 degrees with respect to the front panel 104.

With reference now to FIG. 10, the container 181 in retail in configuration is shown loaded with product 185 that is gravity fed towards the opening 182, from which the product 185 can be withdrawn as indicated. The sill 107 is shown withholding some of the product 185 from being inadvertently removed from the container 181.

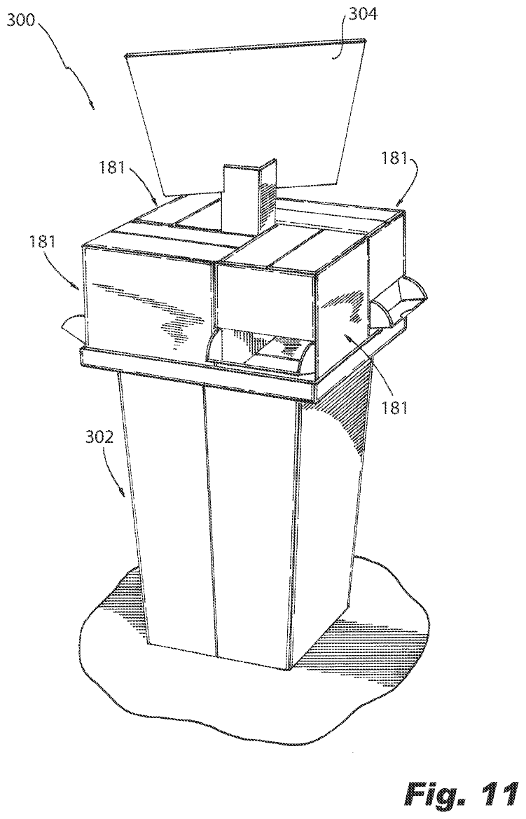

With reference now to FIG. 11, a group of four containers 181 in retail configuration are shown in a typical display configuration 300, e.g., placed into a group and placed atop a floor stand 302 with a product indicia 304 placed among the group to call attention to the display 300.

The methods and systems of the present disclosure, as described above and shown in the drawings, provide for containers with superior properties including improved shipping strength and gravity fed dispensing relative to traditional containers. While the apparatus and methods of the subject disclosure have been shown and described with reference to preferred embodiments, those skilled in the art will readily appreciate that changes and/or modifications may be made thereto without departing from the scope of the subject disclosure.

What is claimed is:

1. A blank for a container comprising:
a plurality of panels connected together at fold lines configured for extending at least partially around an interior space, including a front panel, a first side panel, a rear panel and a second side panel;
a plurality of top flaps and a plurality of bottom flaps foldably connected to opposed edges of each of the first side panel, the second side panel, the front panel, and the rear panel, wherein the plurality of bottom flaps includes a tray flap foldably connected to an edge of the front panel opposite the top flap, the tray flap being configured to fold toward and be adhered to a bird feeder tray defined by a line of weakness in the front panel.

2. The blank as recited in claim 1, wherein the bird feeder tray is defined along a top edge and two side edges of the bird feeder tray by lines of perforation, and is foldably connected to the front panel along a bottom edge of the bird feeder tray.

3. The blank as recited in claim 2, wherein the bird feeder tray is positioned within the front panel, such that a space is maintained between the bottom edge of the bird feeder tray and the foldable connection between the front panel and the tray flap.

4. The blank as recited in claim 2, wherein the bird feeder tray is configured to be manually converted from a shipping configuration to a retail configuration by breaking the lines of perforation and pulling the bird feeder tray away from the front panel to create an opening in the front panel to access the interior space.

5. The blank as recited in claim 4, wherein the tray flap includes a pair of wings foldably connected to opposed edges of the tray flap wherein a curved edge of each wing is radiused to clear an edge of the opening when the bird feeder tray is pulled away from the front panel.

6. The blank as recited in claim 3, wherein each wing includes a locking slot, each locking slot being configured to engage an edge of the opening in the front panel to prevent the bird feeder tray from opening more than 90 degrees with respect to the front panel.

7. The blank as recited in claim 1, wherein the tray flap includes one or more adhesive locations to adhere the tray flap to the front panel when the tray flap is folded.

8. The blank as recited in claim 1, wherein the tray flap includes one or more slits parallel to the fold line between the tray flap and the front panel, wherein the slits are configured to facilitate folding of the tray flap towards the front panel.

9. The blank as recited in claim 1, further comprising an adhesive flap foldably connected to either the rear panel or the first side panel.

10. The blank as recited in claim 9, wherein the tray flap is folded and adhered to the front panel and first side panel and the rear panel are folded such that adhesive flap adheres the panels together into a joined knocked down box.

11. The blank as recited in claim 10, wherein the joined knocked down box is palletized for shipment in bulk.

12. A container comprising:
a plurality of panels connected together at fold lines configured for extending at least partially around an interior space, including a front panel, a first side panel, a rear panel and a second side panel;
a plurality of top flaps and a plurality of bottom flaps foldably connected to opposed edges of each of the first side panel, the second side panel, the front panel, and the rear panel, wherein the plurality of bottom flaps includes a tray flap foldably connected to an edge of the front panel opposite the top flap, the tray flap being configured to fold toward and be adhered to a bird feeder tray defined by a line of weakness in the front panel.

13. The container as recited in claim 12, wherein the bird feeder tray is nicked into place along a top edge and two side edges of the bird feeder tray by lines of perforation, and is foldably connected to the front panel along a bottom edge of the bird feeder tray.

14. The container as recited in claim 13, wherein the bird feeder tray is positioned within the front panel, such that a space is maintained between the bottom edge of the bird feeder tray and the foldable connection between the front panel, wherein the space defines a sill that retains product placed within the interior space.

15. The container as recited in claim 13, wherein the bird feeder tray is configured to be manually converted from a shipping configuration to a retail configuration by breaking the lines of perforation and pulling the bird feeder tray away from the front panel to create an opening in the front panel to access the interior space.

16. The container as recited in claim 15, wherein the tray flap includes a pair of wings foldably connected to opposed edges of the tray flap, the opposed wings being shaped as half-hemispheres, wherein a rounded edge of each wing is radiused to clear an edge of the opening when the bird feeder tray is pulled away from the front panel.

17. The container as recited in claim 16, wherein each wing includes a locking slot, each locking slot being configured to engage an edge of the opening in the front panel to prevent the bird feeder tray from opening more than 90 degrees with respect to the front panel.

18. The container as recited in claim 12, wherein the tray flap includes one or more adhesive locations to adhere the tray flap to the front panel when the tray flap is folded.

19. The container as recited in claim 12, wherein the tray flap includes one or more slits parallel to the fold line between the tray flap and the front panel, wherein the slits are configured to promote folding of the tray flap towards the front panel.

20. The container as recited in claim 12, further comprising an adhesive flap foldably connected to either the rear panel or the first side panel.

21. The container as recited in claim 20, wherein the tray flap is folded and adhered to the front panel and first side panel and the rear panel are folded such that adhesive flap adheres the panels together into a joined knocked down box.
